(19) United States
(12) Patent Application Publication
(10) Pub. No.: US 2013/0338865 A1
(43) Pub. Date: Dec. 19, 2013

(54) Augmented Battery and Ecosystem for Electric Vehicles

(71) Applicant: Panasonic Corporation of North America, Secaucus, NJ (US)

(72) Inventors: David Kryze, Campbell, CA (US); Akihiko Sugiura, Los Altos Hills, CA (US); Tomoya Yamamoto, San Jose, CA (US); Houston Hoffman, Saratoga, CA (US); Deanna Wilkes-Gibbs, Palo Alto, CA (US); Lucas Divine, San Jose, CA (US)

(21) Appl. No.: 13/907,325

(22) Filed: May 31, 2013

Related U.S. Application Data
(60) Provisional application No. 61/653,723, filed on May 31, 2012.

(51) Int. Cl. B60L 11/18

(52) U.S. Cl. CPC B60L 11/1851
USPC 701/22

(57) ABSTRACT

An augmented battery for providing power to a powered vehicle includes a case adapted for removably mounting on the vehicle that encloses: at least one cell disposed within the case that provides power to the vehicle; a power port supported by the case that is adapted to electrically couple the at least one cell to the vehicle; and a processor disposed within the case and having an associated memory that stores program code executable by the processor to selectively communicate through an electronic communication circuit.

### FIELD

The present disclosure relates to an augmented battery and ecosystem for electric vehicles.

### BACKGROUND

This section provides background information related to the present disclosure which is not necessarily prior art. Light electric vehicles, such as electric bicycles, conventionally have employed basic DC batteries that function primarily to supply power to the electric motor. There has heretofore been very little development beyond the basic needs of providing power to the vehicle. However, the applicants have discovered that the battery can be augmented, as described herein, to provide considerable more functionality that has heretofore been available.

### SUMMARY

This section provides a general summary of the disclosure, and is not a comprehensive disclosure of its full scope or all of its features.

As more fully described herein, the augmented battery comprises battery device for supplying power to an electric vehicle that includes a battery disposed within a package adapted for removably mounting on an electric vehicle. The augmented battery further includes a communication system disposed within said package and powered by said battery, the communication system providing wireless connectivity with a portable devices located in proximity to the package and also with networked computer systems. At least one processor is disposed within the package and powered by said battery, the processor being connectable to at least one sensor that senses conditions associated with the electric vehicle.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a functional block diagram of an exemplary augmented battery ecosystem according to the principles of the present disclosure;

FIG. 2 is a flow diagram illustrating an augmented battery equipped vehicle check-in method according to the principles of the present disclosure;

FIG. 3 is a flow diagram illustrating an augmented battery equipped vehicle user preference management method according to the principles of the present disclosure;

FIG. 4 is a flow diagram illustrating an augmented battery equipped vehicle power management method according to the principles of the present disclosure;

FIG. 5 is a flow diagram illustrating an augmented battery equipped vehicle user assistances method according to the principles of the present disclosure;

FIG. 6 is an exemplary personal computing device mounting system according to the principles of the present disclosure;

FIG. 7 is an exemplary augmented battery coupled to an electric bicycle according to the principles of the present disclosure;

FIG. 8 is an exemplary augmented battery utilized as a standalone power station according to the principles of the present disclosure;

FIG. 9 is an exemplary vehicle charging system according to the principles of the present disclosure;

FIG. 10 is a component diagram illustrating an alternative augmented battery and bicycle communication architecture according to the principles of the present disclosure;

FIG. 11 is a functional block diagram of a vehicle lock according to the principles of the present disclosure;

FIG. 12 is a flow diagram illustrating a method for locking and unlocking a vehicle according to the principles of the present disclosure;

FIG. 13A is an exemplary vehicle charging station according to the principles of the present disclosure;

FIG. 13B is an exemplary method for locking and unlocking a vehicle from a charging station;

FIG. 14 is an exemplary augmented battery ecosystem according to the principles of the present disclosure;

FIG. 15 is an alternative exemplary augmented battery ecosystem according to the principles of the present disclosure; and

FIG. 16 is an exemplary vehicle including a plurality of external sensors according to the principles of the present disclosure.

Corresponding reference numerals indicate corresponding parts throughout the several views of the drawings.

### DETAILED DESCRIPTION

Example embodiments will now be described more fully with reference to the accompanying drawings. For purposes of illustration, the augmented battery and ecosystem will be described in conjunction with an electric bicycle. Of course the principles of the disclosed system can be utilized with other types of vehicles.

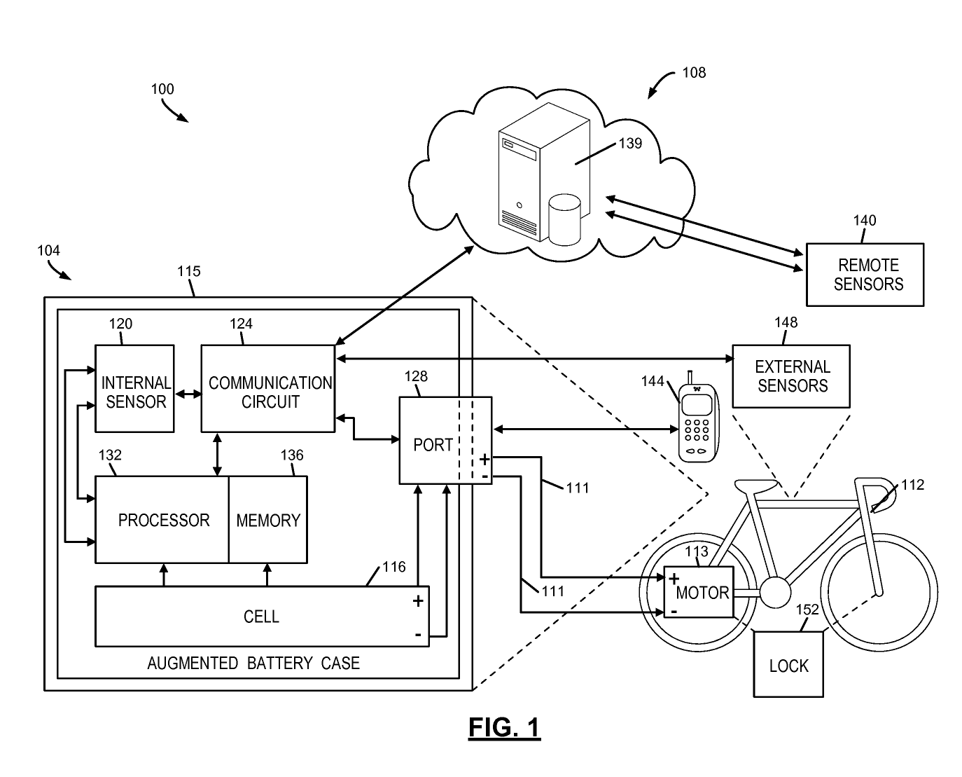

With particular reference to FIG. 1 a functional block diagram of an exemplary augmented battery ecosystem is shown at 100. The ecosystem 100 includes an augmented battery 104, a remotely located service 108, and an electrically powered vehicle 112. The augmented battery 104 is electrically coupled to the vehicle 112. The vehicle 112 is a vehicle capable of carrying a human. The vehicle 112 may be an electric bicycle, an electric wheelchair, and a powered scooter. The vehicle 112 requires a power source capable of powering the vehicle 112 while sustaining operation and carrying the human. For example, an the vehicle 112 power requirement may range from 12 volts to 36 volts and 10 amp hours to 20 amp hours.

The augmented battery 104 is coupled to the vehicle 112 via a power supply cable 111. The augmented battery 104 is configured to supply electric power to the vehicle 112. The electric power is applied to an electric motor 113 coupled to the vehicle 112. The electric motor 113 propels the vehicle 112 using the supplied electric power. While only an electric bicycle is described, it is understood that the principles of the present disclosure apply to any electrically powered vehicle.

The augmented battery 104 is configured to be removably mounted on the vehicle 112. For example, the augmented battery 104 is configured to include a case 115. The case 115 encloses internal components of the augmented battery 104. In some implementations, the case 115 also supports components coupled to the augmented battery 104. The case 115 is configured to include a plurality of vehicle coupling devices. The vehicle coupling devices may include cables, clips, fasteners, and connectors.

The plurality of vehicle coupling devices is arranged on the case 115 in order to couple the augmented battery 104 to the vehicle 112 without having to modify the vehicle 112. It will be understood by those skilled in the art that the vehicle 112 includes a factory supplied battery. The factory supplied battery is arranged to supply power to a motor 113 coupled to the vehicle 112. The motor 113 is configured to electrically control the vehicle 112 based on the supplied power. The augmented battery 104 is configured to replace the factor supplied battery.

In some implementations, the augmented battery 104 includes at least one antenna. The at least one antenna is arranged to communicate with a plurality of networks. For example, the plurality of networks includes a global position system network, a Wi-Fi network, a cellular data network, and any other suitable network technologies. The case 115 is configured to allow the at least one antenna to communicate with the plurality of networks. For example, the case 115 may be comprised of a material that interferes with antenna reception. The material may be a metal with conducting and insulating properties that reduce reception capacities of the at least one antenna. The case 115 is arranged to include an antenna window. The antenna window is comprised of a material having properties that do not interfere with the reception capabilities of the at least one antenna.

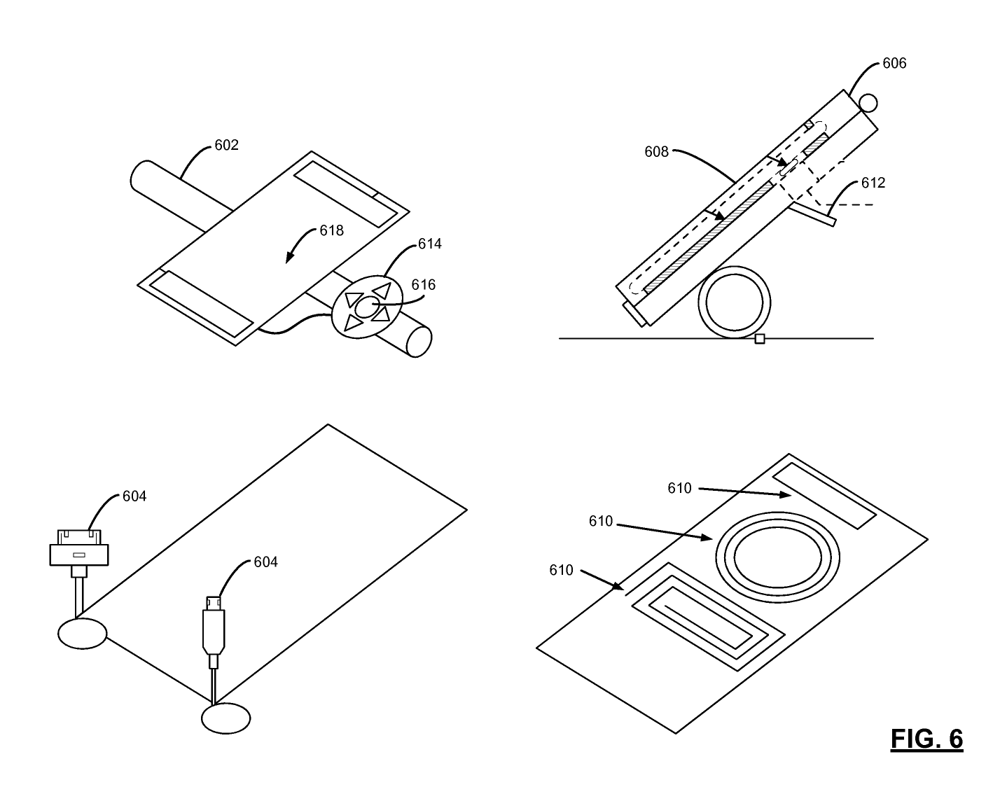

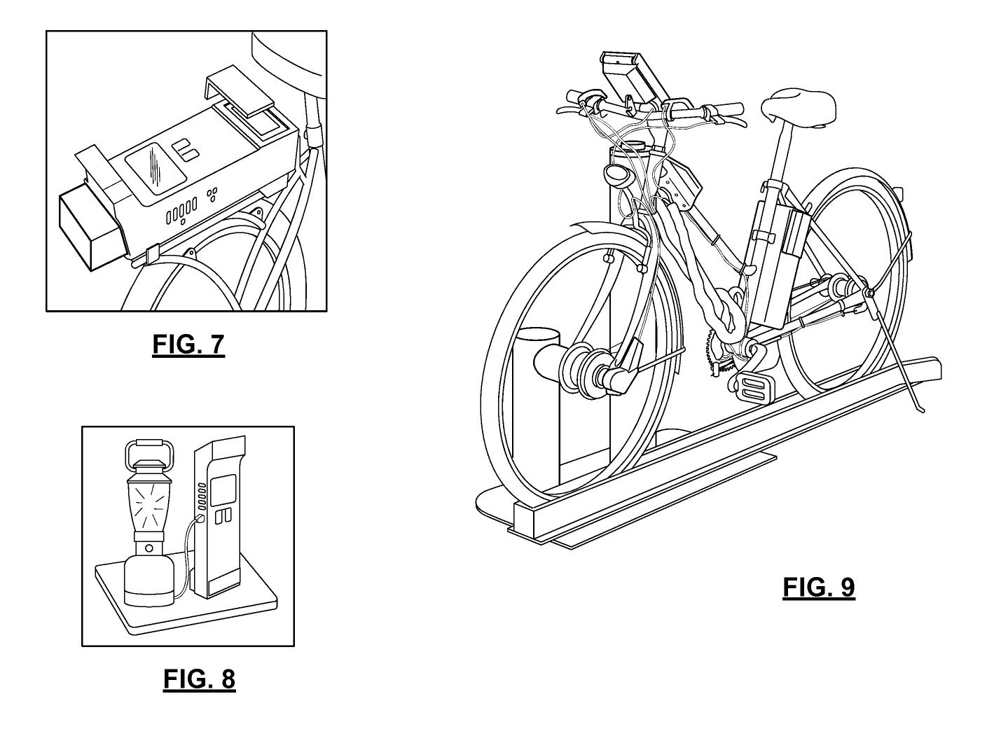

In other implementations, the augmented battery 104 may be retrofitted to a vehicle, such as the vehicle 112. For example, the augmented battery 104 includes an installation kit. The installation kit includes generic vehicle coupling devices. The generic vehicle coupling devices may include clips, fasteners, cables, and connectors. The installation kit is arranged in a predetermined configuration in order to couple the augmented battery 104 to the vehicle 112. An exemplary augmented battery configured to be removably mounted on an electric bicycle is shown generally in FIG. 7.

In yet another implementation, the augmented battery 104 may be removably detached from the vehicle 112 and operated in a standalone mode. The standalone mode includes the augmented battery 104 operating as a mobile hotspot. For example, the augmented battery 104 includes a cellular data connection circuit. The cellular data connection circuit is arranged to connect to a predetermined cellular network. The augmented battery 104 is configured to function as a connection router.

For example, the augmented battery 104 includes a network routing circuit. The network routing circuit shares the cellular data connection with a plurality of authenticated devices, such as a laptop, smart phone, tablet computer, or other device. It will be understood by those skilled in the art that a device may be authenticated before connecting to the network routing circuit. Authentication includes assigning an authentication key and matching the key on the device to a key on the augmented battery 104.

The augmented battery 104 includes at least one cell 116, an internal sensor 120, a communication circuit 124, a port 128, a processor 132, and a memory 136. The cell 116 is arranged to convert chemical energy into electrical energy. The cell 116 may be a rechargeable cell. For example, the cell 116 is configured to electrically couple to a cell charger. The cell charger is configured to supply electric power to the cell 116. The cell 116 is configured to store the electric power.

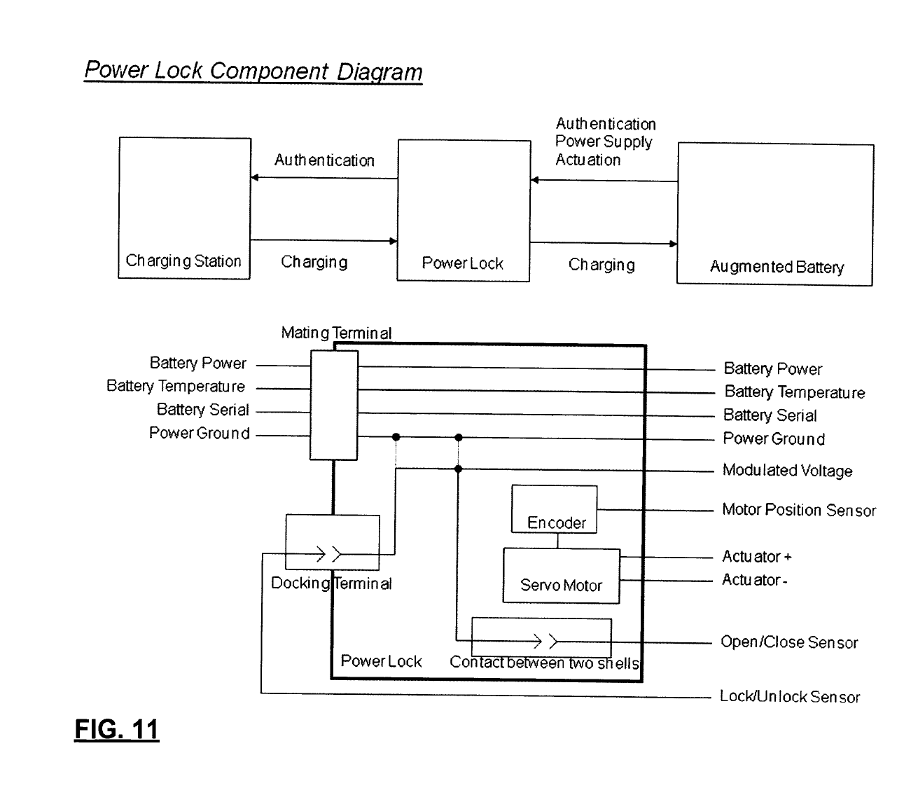

In this way, the cell 116 retains a charge that is distributable to an electrically coupled device, such as the vehicle 112 for example. It is understood that while only a rechargeable cell is described, the principles of the present disclosure apply to any suitable cell technology. Further, the principles of the present disclosure may be applied to wet cells, dry cells, or any other suitable cell types. It is also understood that the cell 116 may be configured as a single cell or a plurality of cells. An alternative component diagram of an augmented battery and bicycle communication architecture are shown generally in FIG. 10.

The cell 116 is electrically configured to supply power to individual components of the augmented battery 104. For example, the cell 116 is electrically coupled to the internal sensor 120, the communications circuit 124, the port 128, the processor 132, and the memory 136. In this way, the cell 116 distributes a stored electrical charge to each of the components of the augmented battery 104. Further, the cell 116 is configured to supply electrical power to a device external to the augmented battery 104.

For example, the cell 116 is electrically coupled to the port 128. The cell 116 includes a positive lead and a negative lead. The positive lead is electrically coupled via a cable to a positive lead of the port 128. Similarly, the negative lead is electrically coupled to a negative lead of the port 128. The port 128 is electrically coupled to the vehicle 112. For example, the positive lead of the port 128 is electrically coupled to a positive lead of the motor 113. Similarly, the negative lead of the port 128 is electrically coupled to a negative lead of the motor 113. The cell 116 supplies electrical power through the port 128 to the vehicle 112. The vehicle 112 is propelled based on the supplied electrical power. Further, the vehicle 112 may include a plurality of accessories (not shown). The plurality of accessories includes at least one vehicle light. The at least one vehicle light is operated using the supplied electrical power.

The internal sensor 120 is configured to sense at least one characteristic of the augmented battery 104. For example, the internal sensor 120 may be a global positioning system (GPS) sensor. The internal sensor 120 communicates with a GPS system remotely located to the augmented battery 104. The internal sensor 120 receives GPS coordinates corresponding to a location of the augmented battery 104. The internal sensor 120 communicates the GPS coordinates to the processor 132. In another implementation the internal sensor 120 may be a charge sensor. The internal sensor 120 senses a charge level, a number of charge cycles, a temperature, an electrical voltage, an electrical current, a discharge time, and a charge capacity of the cell 116. The internal sensor 120 communicates the charge level to the processor 132.

In yet another implementation, the internal sensor 120 may be a plurality of sensors. The plurality of sensors includes a GPS sensor, a charge sensor, and a motion sensor. The internal sensor 120 is configured to receive GPS coordinates corresponding to a location of the augmented battery 104, to sense a charge level of the cell 116, and sense motion of the augmented battery 104. The internal sensor 120 communicates the GPS coordinates, the charge level of the cell 116, and the sensed motion of the augmented battery 104 to the processor 132. In this way, the internal sensor 120 senses characteristics of the augmented battery 104 and communicates the sensed characteristics to the processor 132. It is understood that the internal sensor 120 may be a single sensor or a plurality of sensors. Further, while only a GPS sensor, a charge sensor, and a motion sensor are described, it will be appreciated by those skilled in the art that the internal sensor 120 may be any suitable sensor.

The internal sensor 120 also communicates sensed characteristics of the augmented battery 104 to the communication circuit 124. The communication circuit 124 is configured to communicate the remotely located service 108. For example, the communication circuit 124 communicates over a communication network. The communication network may be a Wi-Fi network or a cellular data network such as 3g, 4g, or LTE. Similarly, the communication circuit 124 may communicate via a Bluetooth connection or a hardwired connection. While only a limited number of communication examples are described, it is understood that the principles of the present disclosure apply to any suitable communication protocols.

The remotely located service 108 is a cloud storage service. The remotely located service 108 may be comprised of a plurality of data storage servers 139. The plurality of data storage servers 139 receives data associated with a remote system 140. For example, the remote system 140 may be a vehicle management system. The vehicle management system manages a fleet of electric bicycles. In one example, a user utilizes the vehicle management system in order to check-out an electric bicycle from the fleet of electric bicycles. For example, the electric bicycle may be the vehicle 112. The user interacts with a manager of the vehicle management system.

The user supplies the manager with information associated with the user in order to check-out the vehicle 112. For example, the information associated with the user may be the user's name, address, telephone number, and credit card information. The manager supplies the vehicle management system with the user information. The manager also supplies the information associated with the vehicle 112 to the vehicle management system. The information associated with the vehicle 112 may be a serial number, model number, and a current condition of the vehicle 112.

The vehicle management system then stores the user information and the vehicle 112 information within a vehicle management database. For example, the vehicle management database may be one of the data storage servers 139. In this way, the vehicle management system correlates a user to an electric bicycle. The manager then queries the vehicle management system in order to determine which electric bicycles of the fleet of electric bicycles are currently checked-out and the associated user information correlating to a checked-out electric bicycle.

The communication circuit 124 communicates with the vehicle management database via a wireless network. For example, the communication circuit 124 communicates the sensed characteristics to the vehicle management database. In one implementation, the user checks-out an electric bicycle from the fleet of electric bicycles, for example, the vehicle 112. The vehicle 112 is configured to include a battery. The user removes the battery from the vehicle 112 and couple the augmented battery 104 to the vehicle 112. The communication circuit 124 then communicates the sensed characteristics of the vehicle 112 to the vehicle management database. For example, the communication circuit 124 communicates GPS coordinates associated with the vehicle 112 to the vehicle management database. The vehicle management database stores the GPS coordinates. The manager then queries the vehicle management database to receive the GPS coordinates.

The communication circuit 124 communicates with the port 128. The port 128 is a connection port arranged to electrically couple the augmented battery 104 to the vehicle 112. Both power to operate the motor 113 and data signals may be communicated through the port 128. In this regard, the port 128 may include a universal serial bus (USB) port, a fire wire port, a proprietary protocol port, or any suitable port technologies capable of coupling the augmented battery 104 and of communicating data signals to the vehicle 112. The port 128 is configured to receive a connecting device coupled to the vehicle 112. The connecting device is a cable suitable or interfacing with the port technologies described above. The port 128 generates a connect signal when the port 128 receives the connecting device.

The port 128 communicates the connect signal to the communication circuit 124. The communication circuit 124 communicates the connect signal to the processor 132 and the remotely located service 108. The port 128 also generates a disconnect signal. For example, when the connecting device is disconnected from the port 128, the port 128 generates a disconnect signal. The port 128 communicates the disconnect signal to the communication circuit 124.

In some implementations, the port 128 is configured to couple the augmented battery 104 to a personal computing device 144. The personal computing device 144 may be a smart phone, a tablet computer, a laptop computer, or any other suitable personal computing device. The port 128 is configured to receive a personal computing connecting device. For example, the personal computer device 144 includes a connecting port. The connecting port utilizes a cable configured to connect the personal computing device 144 to other devices. The connecting port follows a communication protocol specific to the personal computing device 144. The port 128 is configured to receive the connecting device and interpret the communication protocol specific to the personal computing device 144.

In some implementations, the augmented battery 104 is configured to be removably detached from the vehicle 112 and function as a standalone power source. For example, the port 128 is arranged to receive a plurality of connecting devices. The plurality of connecting devices couple the port 128 to a plurality of standalone devices. The standalone devices may include a laptop computer, a smart phone, a light, or another other device that may require a power source. The augmented battery 104 supplies power to the standalone devices via the port 128. An exemplary augmented battery arranged to function as a standalone power source is shown generally in FIG. 8.

Augmented Battery Integration with a Device Mounting System

In some implementations, the personal computing device 144 is coupled to the vehicle 112 via a device mounting system. The device mounting system is physically coupled to a steering mechanism of the vehicle 112 as shown in FIG. 6. For example, the vehicle 112 may include a handlebar 602. The device mounting system is physically coupled to the handlebar 602. The device mounting system includes a plurality of cables 604. The plurality of cables 604 includes a connecting cable suitable to interface with the connecting port of the personal computing device 144 (e.g., smartphone).

In some implementations, the device mounting system is configured to be coupled to the port 128. The plurality of cables 604 are configured to interface with the port 128. The personal computing device 144 communicates with the augmented battery 104 via the device mounting system. In another implementation, the device mounting system communicates with the communication circuit 124 via a wireless connection such as Wi-Fi, 3g, 4g, LTE, or Bluetooth.

The device mounting system also includes an enclosure 606. The enclosure 606 surrounds the personal computing device 144 when the personal computing device 144 is mounted in the device mounting system. The enclosure 606 is configured to be comprised of a clear front window area 608 configured to allow the user to access the personal computing device 144. For example, the clear front window 608 is comprised of a plastic screen that allows the user to see and interface with the personal computing device 144. The plastic screen also covers the personal computing device 144 in order to protect the personal computing device 144 from hazards encountered while the user is operating the vehicle 112.

The device mounting system includes a sensor area 610. The sensor area 610 includes a plurality of sensors. The plurality of sensors may include a microphone sensor, a light sensor, and a proximity sensor. The microphone sensor is arranged to sense audible signals and communicate the sensed audible signals to the personal computing device 144. The light sensor is arranged to sense light surrounding the vehicle 112 and communicate the sensed light to the personal computing device 144. The proximity sensor is arranged to sense motion surrounding the vehicle 112. For example, the proximity sensor senses a motion made by the user. The proximity sensor senses the motion made by the user and communicates the motion to the personal computing device 144.

The device mounting system also includes a mirror 612. The mirror 612 is arranged to allow a camera integrated within the personal computing device 144 to capture images of a road on which the vehicle 112 is traveling.

In one implementation, the device mounting system is coupled to a user interface device 614. The user interface device 614 includes a plurality of buttons 616. The plurality of buttons 616 is configured to communicate with the personal computing device 144 through the device mounting system. For example, the user touches one of the plurality of buttons 616 in order to activate a calling feature on the personal computing device 144. The one of the plurality of buttons 616 communicates a signal indicative of the one of the plurality of buttons 616 being touched by the user with the personal computing device 144 via a cable or a Bluetooth connection. The personal computing device 144 activates the calling feature when the personal computing device 144 receives the signal. It is understood that while only a calling feature is described, the plurality of buttons 616 may be configured to activate, interact with, or control any features of the personal computing device 144.

The device mounting system includes a resting surface 618. The resting surface 618 is configured to allow the personal computing device 144 to rest on the device mounting system. The resting surface 618 includes an anti-slip component. For example, the anti-slip component is a surface coated with an adhesive. The adhesive prevents the personal computing device 144 from slipping while resting in the device mounting system. The device mounting system also includes a speaker (not shown). The speaker is coupled to the personal computing device 144 via a cable or a Bluetooth connection. The speaker is configured to amplify an audio signal of the personal computing device 144.

Augmented Battery Integration with a Personal Computing Device Display

In another implementation, the communication circuit 124 communicates with the personal computing device 144 via a wireless connection such as Wi-Fi, Bluetooth, or a cellular data network. The communication circuit 124 also communicates with the personal computing device 144 via the remotely located service 108. For example, the personal computing device 144 communicates with the remotely located service 108 via a wireless or wired connection. The communication circuit 124 also communicates with the remotely located service 108. In this way, the communication circuit 124 communicates indirectly with the personal computing device 144.

The communication circuit 124 communicates the sensed characteristics of the vehicle 112 to the personal computing device 144. The personal computing device 144 is configured to display information associated with the sensed characteristics. For example, the personal computing device 144 receives GPS coordinates from the communication circuit 124. The personal computing device 144 communicates with the remotely located service 108 to receive information associated with the GPS coordinates. The personal computing device 144 then processes the GPS coordinates based on the information associated with the GPS coordinates. The personal computing device 144 displays a map illustrating a current location and current route of the vehicle 112 based on the GPS coordinates.

The processor 132 is configured to execute code stored in the memory 136. The code is comprised of instructions. The instructions are arranged to instruct components of the augmented battery 104 and/or the vehicle 112 to operate in a predetermined mode. When the processor 132 executes the code, the components of the augmented battery 104 and/or the vehicle 112 operated according to the predetermined mode. In one example, the code includes vehicle propulsion instructions. The vehicle propulsion instructions include electrically controlling a plurality of gears of the vehicle 112. When the processor 132 executes the code, the propulsion instructions instruct the cell 116 to supply a predetermined amount of electrical power to at least one gear of the vehicle 112. The at least one gear moves under the force of the electrical power, thereby causing the vehicle 112 to accelerate.

### Augmented Battery Implementation of a Check-Out/Check-In Function

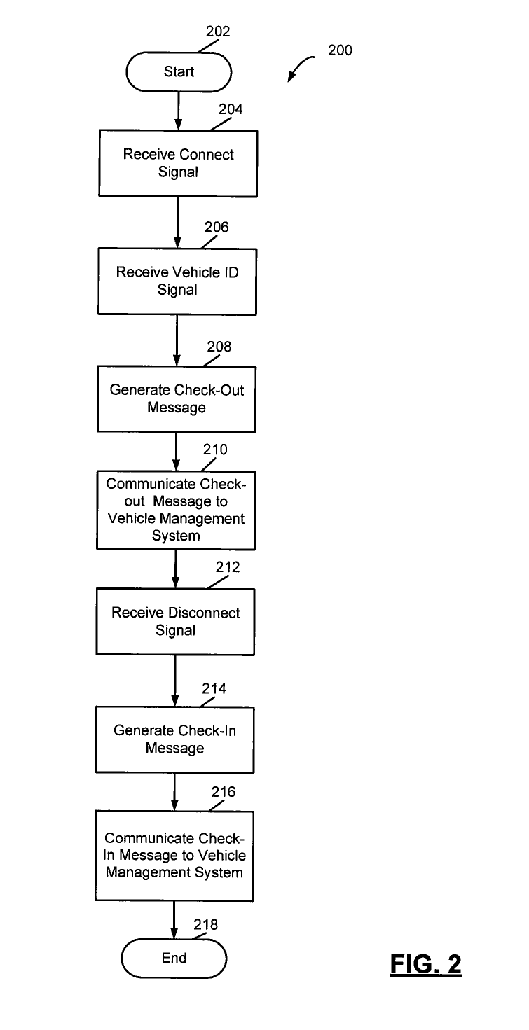

In one implementation, the processor 132 performs a check-in function by executing code stored in the memory 136. A flow diagram illustrating an exemplary vehicle check-in method is shown in FIG. 2 and described in more detail below. The user checks-out the vehicle 112 from the fleet of electric bicycles as described above. Alternatively, the augmented battery 104 automatically checks-out and check-in the vehicle 112. For example, the augmented battery 104 is configured to receive user input data. The user input data includes the user's name, address, credit card information, and other data associated with the user. The user launches an application on the personal computing device 144. The application is configured to allow the user the input the user input data. The personal computing device 144 communicates the user input data to the augmented battery 104.

The augmented battery 104 stores the user input data within the memory 136. Additionally or alternatively, the augmented battery 104 is configured to allow the user to input the user input data. For example, the augmented battery 104 includes a user interface, such as a touch screen or keyboard. The user interface is arranged to receive user input. The user communicates the user input data to the augmented battery 104 via the user interface.

The user couples the augmented battery 104 to the vehicle 112. The port 128 communicates the connect signal to the communication circuit 124. The communication circuit 124 communicates the connect signal to the processor 132. The connect signal may be a data packet. The data packet includes data associated with the vehicle 112. For example, the port 128 receives information stored in memory coupled to the vehicle 112. The information includes a vehicle serial number. The processor 132 executes check-out code stored in the memory 136. When the processor 132 executes the check-out code, the check-out code instructs the internal sensor 120 to determine a GPS coordinate associated with a current location of the augmented battery 104. The GPS coordinates include a latitudinal position, a longitudinal position, and a timestamp. The internal sensor 120 communicates the GPS coordinate to the processor 132.

The processor 132 generates a check-out data packet. The check-out data pack includes the user input data, the vehicle serial number, and the GPS coordinates. The processor 132 communicates the check-out data packet to the communication circuit 124. The communication circuit 124 communicates the check-out data packet to vehicle management system via the remotely located service 108. The vehicle management system receives the check-out data packet and stores the user input data, the vehicle serial number, and the GPS coordinates in the vehicle management system. In this way, the augmented battery 104 automatically checks-out the vehicle 112.

Similarly, when the port 128 is disconnected from the vehicle 112, the port 128 generates a disconnect signal. The processor 132 executes a check-in code stored in the memory 136. The check-in code instructs the internal sensor to determine GPS coordinates associated with a current location of the augmented battery 104. The processor 132 generates a check-in data packet. The check-in data packet includes the user input data, the vehicle serial number, and the GPS coordinates. The processor 132 communicates the check-in data packet to the vehicle management system. The vehicle management system stores the check-in data in the vehicle management database. In this way, the augmented battery 104 automatically checks-in the vehicle 112.

### Augmented Battery Implementation of a Power Management Function

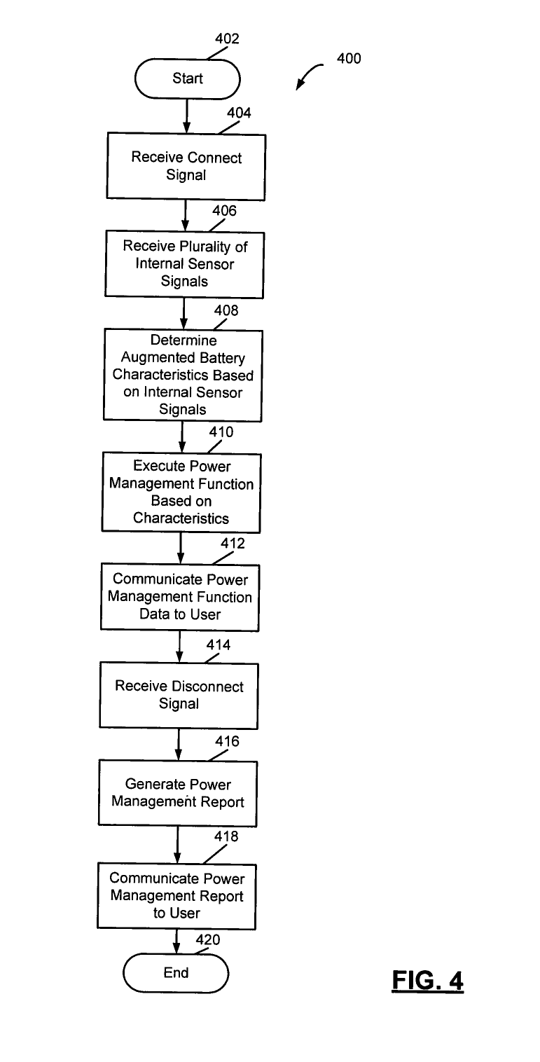

In some implementations, the processor 132 implements a power management function by executing code stored in the memory 136. An flow diagram illustrating an exemplary power management method is shown in FIG. 4 and described in detail below. For example, the power management function includes instructing the internal sensor 120 to sense a charge level of the cell 116. The internal sensor 120 senses the charge level of the cell 116 and communicates the charge level to the processor 132.

The power management function generates a power management instruction based on the charge level. The processor 132 then selectively controls the cell 116 based on the power management instruction. For example only, the charge level indicates that the cell 116 is charged to 50% of capacity. The power management function generates the power management instruction based on a 50% charge of the cell 116. The power management instruction instructs the cell 116 to reduce an amount of electric power supplied to the vehicle 112. In this way, the power management function extends a charge cycle of the cell 116.

### Augmented Battery Implementation of a User Assist Function

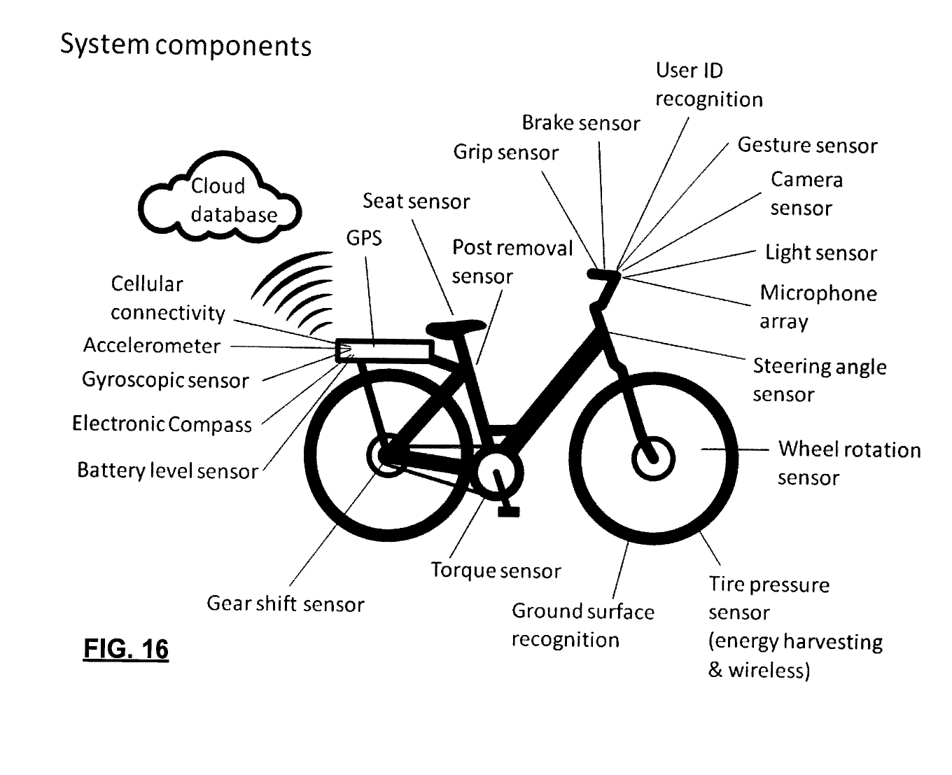

In another implementation, the processor 132 implements a user assist function by executing code stored in the memory 136. For example, the augmented battery 104 communicates with a plurality of external sensors 148. The external sensors 148 includes a tire pressure sensor, a brake wear sensor, a gear turn sensor, a user pulse sensor disposed on a steering mechanism of the vehicle 112, at least one user characteristic sensor disposed within a wearable device, a motion sensor, a level sensor, a GPS sensor, and a lock sensor. It is understood that while only a limited number of example sensors are described, the principles of the present disclosure apply to any suitable sensor. An exemplary vehicle including a plurality of external sensors is shown generally in FIG. 16.

The communication circuit 124 receives a plurality of sensed data from the plurality of external sensors 148. The communication circuit 124 communicates the plurality of sensed data to the processor 132. The processor 132 executes the power management function based on data received from the internal sensor 120 and the external sensors 148. For example, the processor 132 receives the charge level from the internal sensor 120. The processor 132 also receives a sensed user pulse and a sensed revolutions per minute (RPM) of a gear of the vehicle 112. The sensed user pulse is sensed by pulse sensors coupled to a steering mechanism of the vehicle 112. For example, the vehicle 112 is arranged to include a handlebar. The handlebar includes pulse sensors. When the user's hands are on the handlebar, the pulse sensors sense a user pulse.

Alternatively, the sensed user pulse is sensed by a plurality of sensors disposed within a wearable device. For example, the plurality of sensors are disposed within a jacket worn by the user, a leg clip worn by the user, or wrist band worn by the user. It is understood that while only a jacket, leg clip, and wrist band are described, the principles of the present disclosure apply to all wearable devices. The plurality of sensors disposed within the wearable device sense characteristics of the user, for example, a user pulse. The plurality of sensors is configured to communicate the sensed characteristics to the communication circuit 124. In one implementation, the plurality of sensors are coupled to the vehicle 112 via a cable. The port 128 receives the sensed characteristics through the cable.

Alternatively, the plurality of sensors are arranged to communicate wirelessly with the augmented battery 104. For example, the wearable device includes a communication device. The communication device connects and communicates with the communication circuit 124 via a Wi-Fi, Bluetooth, 3g, 4g, or LTE connection. The plurality of sensors communicates the sensed characteristics to the communication device. The commination device communicates the sensed characteristics to the communication circuit.

### Augmented Battery Implementation of an Alternative Power Management Function

The processor 132 executes the power management function code. The power management function generates a power management instruction based on the charge level, the sensed user pulse, and the sensed RPM of the gear. The processor 132 selectively controls the cell 116 based on the power management instruction. For example only, the charge level indicates the cell 116 is above 50% of a charge capacity, the sensed user pulse indicates the user has an elevated heart rate indicating the user is overexerting in order to pedal the vehicle 112, and the sensed RPM indicates the vehicle 112 is decelerating.

The power management function generates a power management instruction that instructs the cell 116 to increase an amount of electric power supplied to the vehicle 112. The power management function then receives other sensed characteristics after a predetermined period and selectively adjusts the power management instruction based on the other sensed characteristics. For example, the power management function instructs the cell 116 to reduce the amount of electric power supplied to the vehicle 112 when the sensed user pulse indicates the user's heart rate has normalized.

### Augmented Battery Implementation of a User Safety Assistance Function

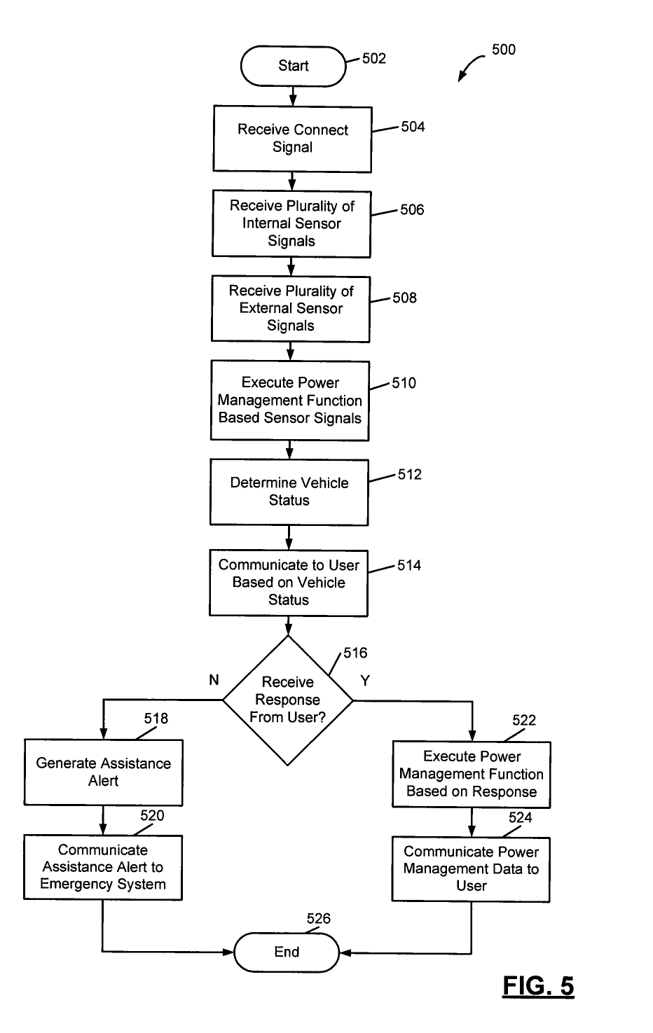

In another example, the processor 132 implements a user safety assistance function by executing code stored in the memory 136. A flow diagram illustrating an exemplary user assist method is shown in FIG. 5 and described in detail below. For example, the vehicle 112 is configured to include a level sensor and an impact sensor. The level sensor is configured to sense a position of the vehicle 112 relative to a level position with the ground. The level sensor communicates the sensed position to the augmented battery 104. The impact sensor is configured to sense a force applied to the vehicle 112. The impact sensor communicates the force to the augmented battery 104.

The safety assistance function determines whether the force is greater than a predetermined force threshold. For example, the predetermined force threshold is a force indicative of a force associated with the vehicle 112 crashing. When the safety assistance function determines the force is above the force threshold, the safety assistance function determines whether the vehicle 112 is upright. The safety assistance function determines whether the vehicle 112 is upright by determining whether the sensed position is greater than a predetermined position threshold.

For example, the sensed position indicates the vehicle 112 is 15 degrees off from level. The predetermined position threshold may be five degrees off from level. When the safety assistance function determines the sensed position of the vehicle 112 is greater than the position threshold, the safety assistance function generates a user assistance message. The user assistance message requests a response from the user indicating the user received the communication.

The safety assistance function communicates the user assistance message to the communication circuit 124. The communication circuit 124 communicates the user assistance message to the user via the personal computing device 144. Alternatively, the augmented battery 104 includes a speaker. The communication circuit 124 communicates the user assistance message via the speaker.

The user then responds to the user assistance message by acknowledging receipt of the message. For example, the user selects a response button on a touch interface of the personal computing device 144. Alternately, the augmented battery 104 includes a user interface. The user interface may be a touch screen or a keyboard. The user inputs a response directly to the augmented battery 104 by interfacing with the user interface.

The safety assistance function contacts an emergency system based on the user response. For example, the augmented battery 104 communicates the response to the safety assistance function. When the safety assistance function receives the response, the safety assistance function determines whether the user requires assistance from an emergency system. The emergency system may be a local police department or local ambulance dispatch. The safety assistance function determines the closest emergency system. For example, the safety assistance function communicates via the communication circuit 124 with the remotely located service 108. The remotely located service 108 is configured to communicate with a plurality of emergency systems.

The safety assistance function generates an assistance message based on the response. For example, when the response indicates the user does not need assistance, the safety assistance function does not generate an assistance message. When the response indicates the user requires assistance, the safety assistance function generates the assistance message. The assistance message includes the user name, a telephone number associated with the user, GPS coordinates received from the internal sensor 120, and a brief message indicating the vehicle 112 has crashed and the user needs emergency assistance.

Further, if the safety assistance function does not receive a response from the user after a predetermined period, the safety assistance function generates the assistance message. The safety assistance function communicates the assistance message to the communication circuit 124. The communication circuit 124 communicates the assistance message to the remotely located service 108.

The remotely located service 108 then communicates the assistance message to at least one emergency system. For example, the remotely located service 108 communicates the assistance message to a local police department. The local police department is arranged to include an assistance message receiving device. The assistance message receiving device may be comprised of a processor configured to receive and interpret the assistance message. The local police department then executes an assistance policy arranged to contact the user and/or send assistance to the user's location.

### Augmented Battery Implementation of a User Preference Function

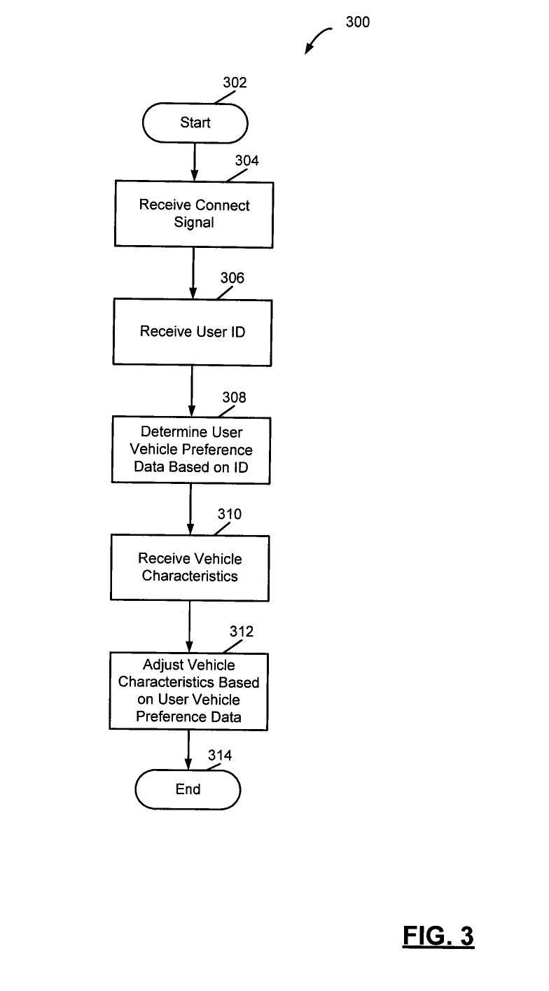

In another implementation, the processor 132 implements a user preference function by executing code stored in the memory 136. A flow diagram illustrating an exemplary user preference method is shown in FIG. 3 and described in detail below. For example, the vehicle 112 is configured to include a plurality of user adjustable components. The plurality of user adjustable components may include, but is not limited to, a height adjustable seat, a temperature adjustable seat cover, an adjustable handlebar, and adjustable brake tension. In some implementation, at least one of the plurality of user adjustable components is hydraulically or electrically controlled. For example only, the height adjustable seat is hydraulically controlled and the temperature adjustable seat cover is electrically controlled.

In some implementations, the user records a plurality of user preferences. For example, the user interfaces with the augmented battery 104 via the personal computing device 144 or the user interface integrated within the augmented battery 104. The user communicates to the augmented battery 104 a preferred seat height and a starting seat temperature. For example, the user may prefer a seat height of five inches above the vehicle 112 frame. Further, the user may prefer the temperature adjustable seat to start on the hottest temperature setting when the augmented battery 104 is first coupled to the vehicle 112. The augmented battery 104 receives the connect signal from the port 128 when the augmented battery 104 is coupled to the vehicle 112. The processor 132 implements the user preference function upon receiving the connect signal.

The user preference function determines a current position and/or state of the user adjustable components. For example, each user adjustable component is arranged to include a position sensor. The position sensors are configured to determine a current position of the associated user adjustable component. The position sensors communicate the current positions of the user adjustable components to the communication circuit 124.

The communication circuit 124 communicates the current positions of the user adjustable components to the processor 132. The user preference function selective generates an adjustment instruction based on the current positions of the user adjustable components. For example, the height adjustable seat has a current position of three inches above the frame. The user preference function generates an instruction that includes increasing the height of the height adjustable seat two inches. The processor 132 communicates the instruction to the communication circuit 124. The communication circuit 124 communicates the instruction to the vehicle 112.

In another example, the current position of the temperature adjustable seat cover is in an off position. The user preference function generates an instruction that includes turning the temperature adjustable seat cover on.

In another implementation, vehicle 112 includes an electrically powered bottle holder. The bottle holder is arranged to include a plurality of bottle sensors. The plurality of bottle sensors includes, but is not limited to, a volume sensor and a temperature sensor. For example, the volume sensor is arranged to sense a weight of a bottle holstered in the bottle holder. The volume sensor communicates the weight to the augmented battery 104.

The processor 132 implements a bottle volume function by executing code stored in the memory 136. The bottle volume function includes determining a volume of the bottle based on the weight of a unit of water, the received weight and a plurality of predefined bottle preferences. For example, the predefined bottle preferences includes a known empty bottle weight. The bottle volume function determines a current volume of water in the bottle based on the weight of a unit of water, the received weight, and the known empty bottle weight.

The temperature sensor is arranged to sense a temperature of the bottle. The temperature sensor communicates the sensed temperature to the augmented battery 104. The processor 132 implements a bottle temperature function by executing code stored in the memory 136. The bottle temperature function is configured to communicate a current temperature of the bottle to the user. For example, the bottle temperature function communicates the sensed temperature to the user via personal computer device 144.

In another example, the bottle temperature function includes adjusting a temperature of the bottle. For example, the bottle holder is configured to include an adjustable cooling device. The bottle temperature function receives the sensed temperature and determines whether to adjust the bottle temperature based on a comparison of the sensed temperature and a temperature threshold. For example, the temperature threshold is user adjustable. The temperature threshold may be 5 degrees Celsius.

When the bottle temperature function determines the sensed temperature is above the threshold temperature, the bottle temperature function instructs the bottle holder to turn on the adjustable cooling element. The bottle temperature function waits a predetermined period then instructs the bottle holder to turn off the adjustable cooling device. Alternatively, the bottle temperature function instructs the bottle holder to turn off the adjustable cooling device based on another sensed temperature.

### Augmented Battery Implementation of a Vehicle Self-Health Function

In yet another implementation the vehicle 112 includes a tire pressure sensor and a brake pad sensor. The processor 132 implements a self-health function based on sensed data received from the tire pressure sensor and the brake pad sensor. For example, the tire pressure sensor senses a current tire pressure and communicates the current tire pressure to the augmented battery 104. The self-health function is configured to determine whether a tire pressure of a tire of the vehicle 112 is low based on the current tire pressure. The self-health function compares the current tire pressure to a predetermined tire pressure threshold.

When the current tire pressure is less than the tire pressure threshold, the self-health function instructs the communication circuit 124 to communicate a tire low message to the user. For example, the communication circuit 124 communicates the tire low message to the personal computing device 144. Alternatively, the communication circuit 124 generates an audible signal indicating to the user a tire has low tire pressure.

The self-health function determines whether a brake pad of the vehicle 112 is due for replacement. For example, the brake pad sensor is comprised of a wire embedded in the brake pad. When the brake pad wears down, the wire is exposed. When the wire is exposed it makes contact with a metal surface of a wheel of the vehicle 112. When the wire makes physical contact with the wheel, the connection completes an electrical circuit. The electrical circuit is arranged to generate a signal indicative of the wire making contact with the wheel. The signal is communicated to the augmented battery 104. The self-health function determines the brake pad is due for replacement based on the signal. The self-health function communicates to the user the brake pad is due for replacement.

In another embodiment, the self-health function communicates with a vehicle repair shop. For example, the self-health function communicates a brake pad replacement message to the communication circuit 124. The brake pad replacement message includes the location of the brake pad, the user's name, the serial number of the vehicle 112, and a timestamp. The communication circuit 124 is configured to communicate the brake pad replacement message to the vehicle repair shop via the remotely located service 108. The vehicle repair shop is configured to receive the brake pad replacement message.

Augmented Battery Integration with a Vehicle Charging Station

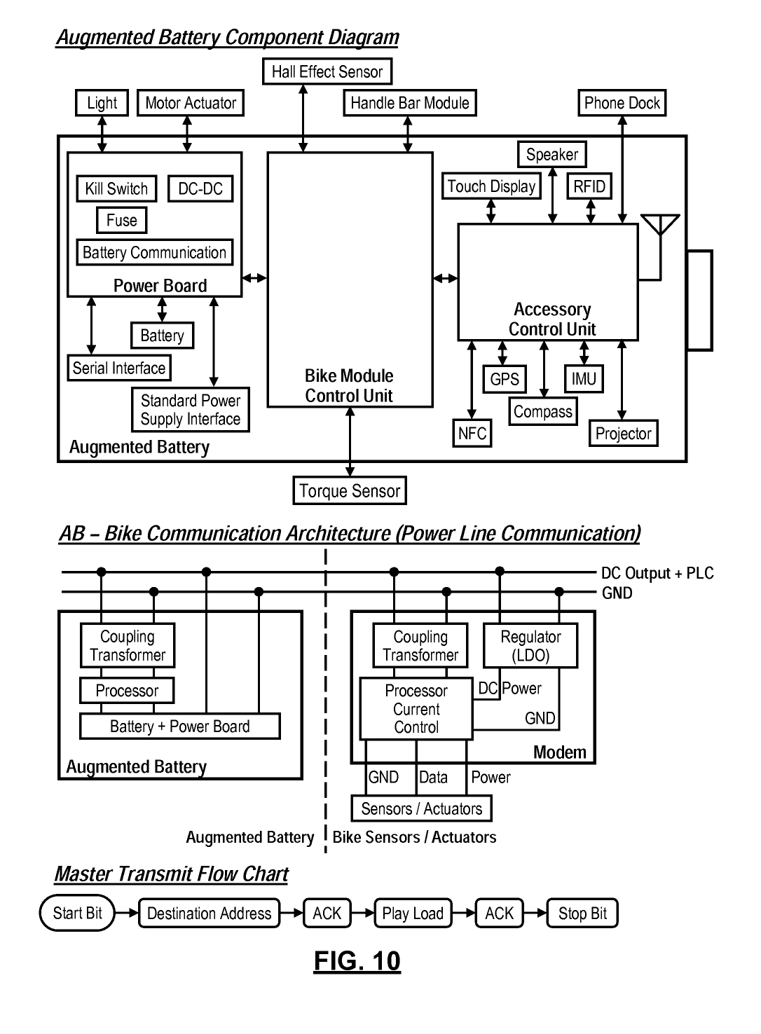

In another implementation, the augmented battery 104 is configured to communicate with a vehicle charging station. For example, the vehicle 112 is configured to be physically and electrically coupled to a charging station as shown generally in FIG. 9. The charging station is configured to receive the vehicle 112 and to provide electrical power to the augmented battery 104. The augmented battery 104 stores the electrical power supplied by the charging station. In this way, the charging station is capable of charging the augmented batter 104. In some implementations, the augmented battery 104 performs an authentication function.

For example, the processor 132 implements the authentication function by executing code stored in the memory 136. The authentication function is configured to determine whether the charging station is a valid charging station. For example, the authentication function receives a first authentication key from the charging station and a second authentication key from the augmented battery 104. The charging station is configured to receive the first key from the user or any other authenticated source. The augmented battery 104 is also configured to receive the second key from the user or an authenticated source. For example, the authenticated source may be a vehicle protection function implemented on the personal computing device 144.

The vehicle protection function receives security information from the user. The security information includes a serial number of the augmented battery 104 and a serial number of the charging station. The vehicle protection function generates the first key and the second key based on the security information.

The first key and the second key is a text string randomly generated to be unique from other keys but identical to each other. In another implementation, the first key and the second key are complimentary of each other. The vehicle protection function communicates the first key to the charging station and the second key to the augmented battery 104.

The authentication function compares the first key to the second key. When the authentication function determines the first key is identical to the second key, the authentication function determines the charging station is a valid charging station. Conversely, when the authentication function determines the first key is not identical to the second key, the authentication function determines the charging station is not a valid charging station.

The authentication function selectively instructs the port 128 to electrically uncouple the augmented battery 104 from the charging station. In this way, the authentication function prevents the augmented battery 104 from receiving an improper power charge.

Further, the augmented battery 104 is configured to charge on a user known charging station, such as a home charging station. When the augmented battery 104 is coupled to an invalid charging station, the authentication function determines the vehicle 112 has been stolen. The authentication function generates an alert. The authentication function communicates the alert to the user via the personal computing device 144. Further, the authentication function generates an audible signal indicating the vehicle 112 has been stolen.

Augmented Battery Integration with a Power Lock

The augmented battery 104 is also configured to communicate with a lock 148. The lock 148 is an electric lock arranged to tether the vehicle 112 to a secure device. For example, the lock 148 secures the vehicle 112 to a bicycle rack. In some implementations, the lock 148 is configured to include a plurality of lock sensors.

The plurality of lock sensors include, but is not limited to, a security sensor, a motion sensor, a charge sensor. The processor 132 is configured to implement a lock management function by executing code stored in the memory 136. The lock management function includes communicating a charge level of the lock 148 to the user. For example, the charge sensor of the lock 148 is configured to determine a charge level of a cell disposed within the lock 148. The cell supplies power to the lock 148. The lock 148 utilizes the supplied power in order to power components of the lock 148, such as a user interface.

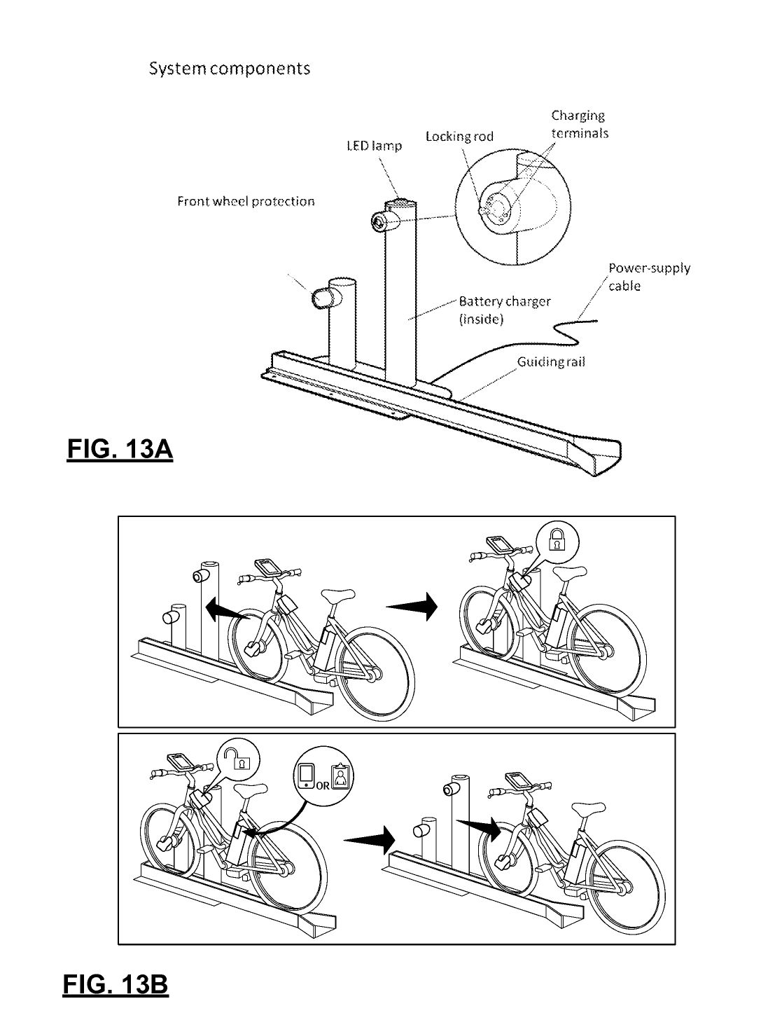

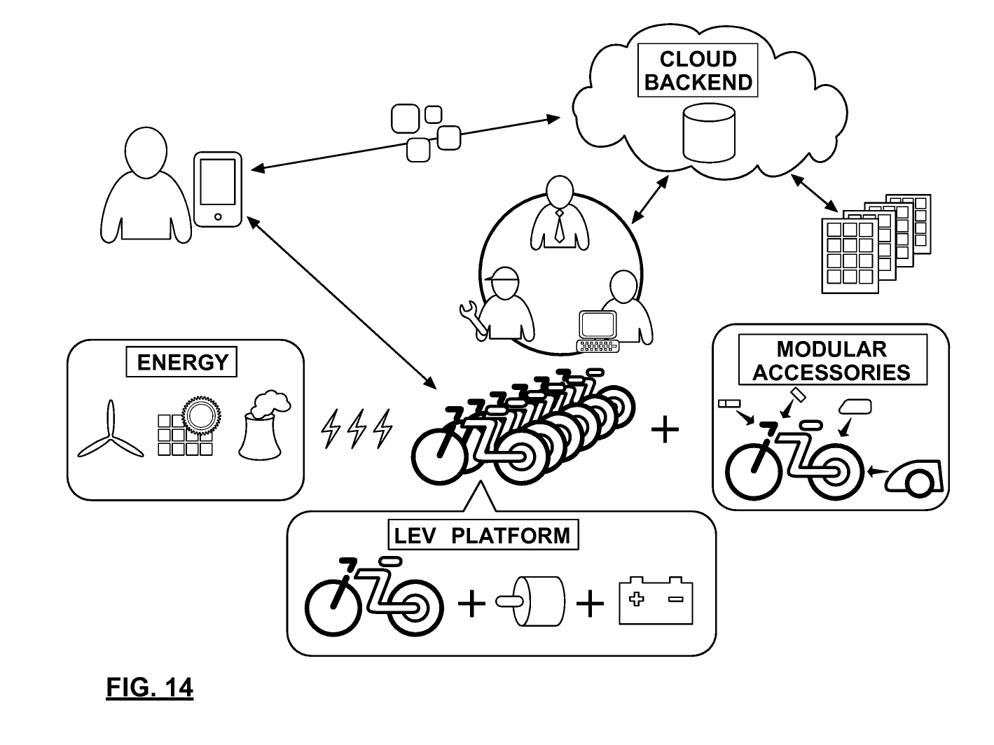

The charge sensor communicates the charge level to the augmented battery 104. The lock management function generates a charge level message based on the charge level. The lock management function communicates the charge level message to the communication circuit 124. The communication circuit 124 communicates the charge level message to the user. An exemplary component diagram of an exemplary charging station is shown generally in FIG. 13A. Additionally, an exemplary method for locking an electric bicycle to a charging station is illustrated generally at FIG. 13B. For example, a user rolls the bicycle along a guiding rail until the bicycle reaches the end of the guiding rail. The user then leans the bicycle against a main attachment pole to insert at locking rod into a power lock. The power lock automatically locks and begins recharging the augmented battery 104.

The user then swipes a registration identification device (i.e., such as the personal computing device 144), on an NFC/RFID reader coupled to the bicycle. Alternatively, the user places the personal computing device 144 in a device mounting dock coupled to a handlebar of the bicycle. In another implementation, the user inputs a pin code using a key pad on the power lock, or a biometric sensor (such as a finger print scanner, face recognition, or voice recognition device). The bicycle then communicates with a server to verify the user's identification. When the user identification is verified, the power lock unlocks.

In another example, the lock management function determines whether the lock 148 has been tampered with. For example, the security sensor is configured to sense unauthorized attempts to access the lock 148. The lock 148 includes a user interface. The user interface is configured to receive a lock code to unlock the lock 148. The security sensor is configured to sense an attempt to unlock the lock 148. The security sensor communicates the sensed attempt to the augmented battery 104. The lock management function determines whether the sensed attempt was a valid attempt.

For example, the lock management function compares the user input associated with the sensed attempt with a predetermined lock code. The predetermined lock code is identical to the code utilized to unlock the lock 148. When the lock management function determines the sensed attempt was not identical to the predetermined lock code, the lock management function stores a value indicative of a first failed attempted. The lock management function receives a second sensed attempt.

When the lock management function determines the second sensed attempt is identical to the predetermined lock code, the lock management system determines an authenticated user has unlocked the lock 148. Conversely, when the lock management function determines the second sensed attempt is not identical to the predetermined lock code, the lock management function generates an alert indicative of an unauthorized attempted to unlock the lock 148. The lock management function communicates the alert to the communication circuit 124.

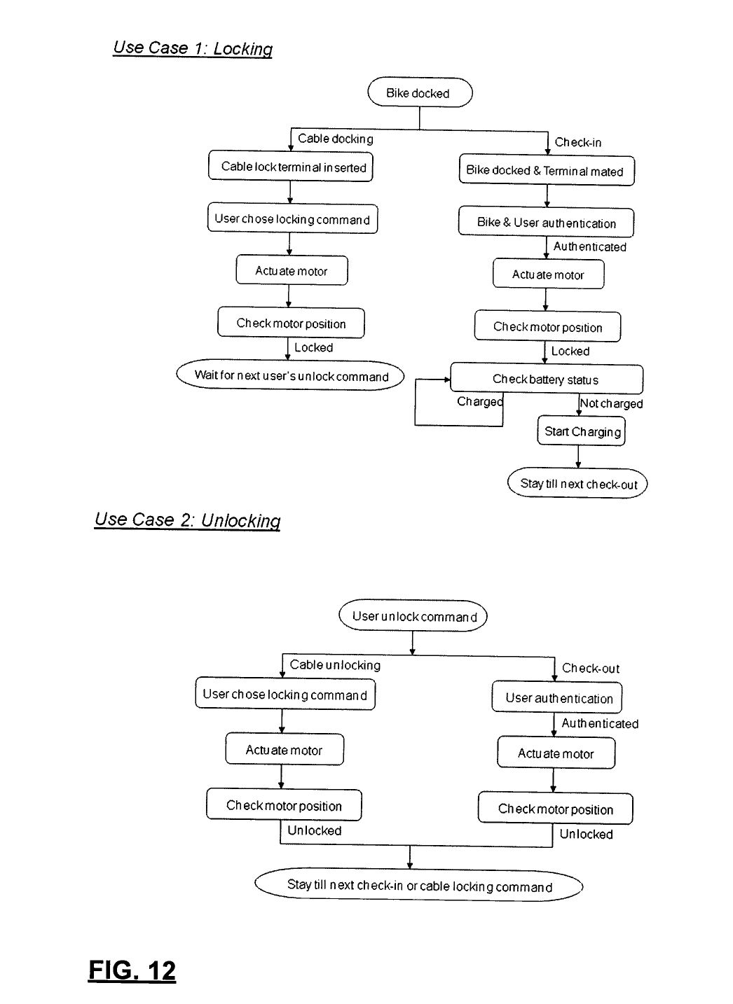

The communication circuit 124 communicates the alert to the user. Additionally or alternatively, the communication circuit 124 generates an audible signal indicating the unauthorized attempt to unlock the lock 148. An exemplary power lock component diagram is shown generally in FIG. 11. Additionally, a first use case and a second use case for locking and unlocking an exemplary power lock according to the principles of the present disclosure are shown generally at FIG. 12.

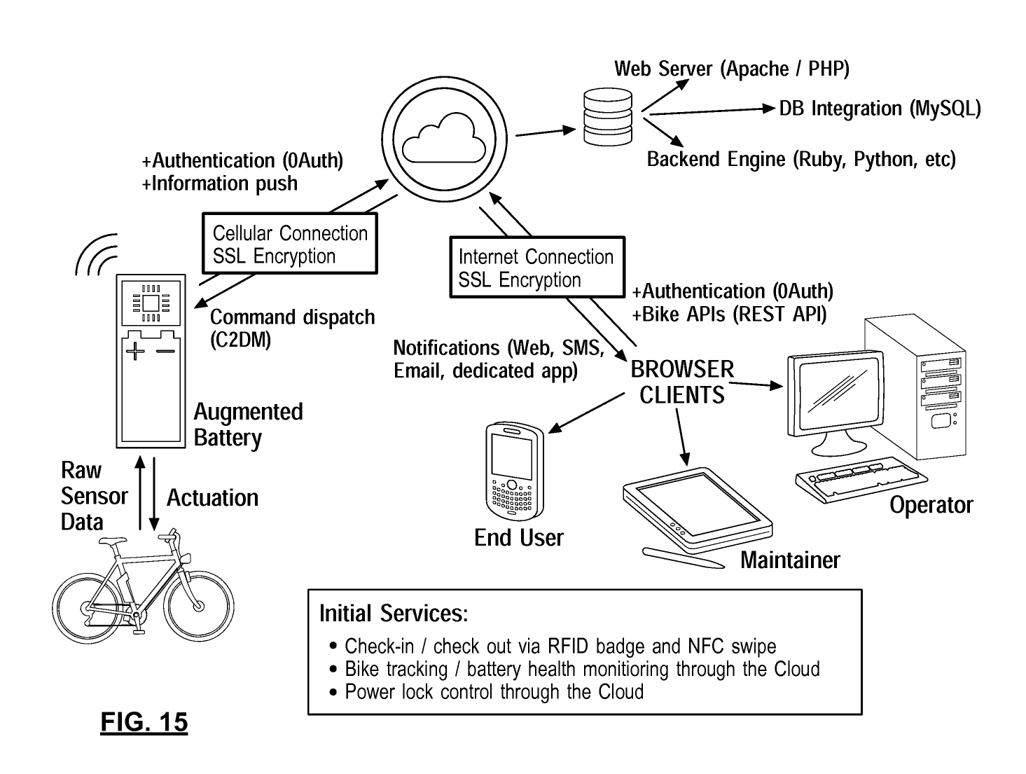

In some implementations, the augmented battery 104 is configured to operate within the ecosystem 100. For example, the augmented battery 104 communicates a plurality of augmented battery characteristics to a plurality of other augmented batteries arranged to operate within the ecosystem. Alternatively, the augmented battery 104 communicates with a plurality of computing devices arranged to operate within the ecosystem. An exemplary augmented battery ecosystem is shown generally in FIG. 14. Additionally, an alternative exemplary augmented battery ecosystem is shown generally in FIG. 15.

### Augmented Battery Implementation of a Group Riding Function

In some implementations the augmented battery 104 operates within the ecosystem 100 in order to implement a group riding function. For example, the processor 132 implements the group riding function by executing code stored in the memory 126. The group riding function includes implementing various functions described above, including the self-health function, the user assist function, and the power management function.

Additionally, the group riding function includes communicating with a plurality of other augmented batteries coupled to other vehicles within the ecosystem 100. For example, each of the other vehicles implements a self-health function, a user assist function, and a power management function. Each of the plurality of other augmented batteries and the augmented battery 104 communication with one and other to share data related to implementing the various described functions. In this way, each of the augmented batteries and the augmented battery 104 is aware of a performance of the other augmented batteries.

In some implementations, the group riding function includes associating the augmented battery 104 and the other augmented batteries. For example, the group riding function receives a plurality of other augmented battery data. The plurality of other augmented battery data includes a unique identified for each of the other augmented batteries. The group riding function associates the unique identifier with a group. The group riding function then communicates with the other augmented batteries by sending data to the group as a whole.

In another implementation, the group riding function includes managing the group routes and traffic. For example, the group riding function determines a route for the group to travel. The group riding function receives a plurality of route data from the remotely located service 108. The remotely located service 108 is configured to communicate with a plurality of traffic and road commission sources. For example, the remotely located service 108 communicates with a government operated road management system. Similarly, the remotely located service 108 communicates with a local traffic system.

The plurality of route data includes current construction projects, road conditions, and accident reports. The group riding function also receives user route input. For example, the user route input includes a user desire to take a scenic route or a faster route. The group riding function generates the group route based on the plurality of route data and the user route input. In another implementation, the group riding function receives traffic light data from the remotely located service 108.

The traffic light data includes traffic light timing. The group riding function generates the route based on the traffic light timing and a plurality of vehicle data. The plurality of vehicle data includes a vehicle speed associated with each of the plurality of other vehicles and the total number of vehicles. The group riding function determines an average speed for the entire group of other vehicles. The group riding function generates the group route based on the average speed and the traffic light timing.

In another implementation, the group riding function communicates group data with a plurality of other devices. For example, the plurality of other devices includes automobiles and other electric bicycles not in the group. The automobiles and other electric bicycles is configured to receive data from the group riding function. The group riding function communicates the total number of vehicles in the group, an average speed of the group, and other suitable group data. In this way, the automobiles and other electric bicycles selectively adjusts a route based on the group data.

In another implementation, the augmented battery 104 communicates with devices near the vehicle 112. For example, the augmented battery 104 receives proximity signals from a plurality of other vehicles traversing the same or crossing route as the vehicle 112. The augmented battery 104 communicates an alert to the user of the vehicle 112 and/or users of the other vehicles based on the proximity signals. The alert indicates to the users a speed of the vehicle 112, a route of the vehicle 112, and any other suitable data related to the vehicle 112. The augmented battery 104 also receives similar data from the other vehicles. The augmented battery 104 generates an alert indicative of a possible collision or traffic slowdown to the user based on the similar data received from the other vehicles.

With particular reference to FIG. 2, an exemplary augmented battery equipped vehicle check-in method 200 begins at 202. At 204, the method 200 receives a connect signal from the power 128. At 206, the method 200 receives a vehicle identification signal. At 208, the method 200 generates a check-out message. At 210, the method 200 communicates the check-out message to a vehicle management system. At 212, the method 200 receives a disconnect signal from the port 128. At 214, the method 200 generates a check-in message. At 216, the method communicates the check-in message to the vehicle management system. The method 200 ends at 218.

With particular reference to FIG. 3, an exemplary augmented battery equipped vehicle user preference management method 300 begins at 302. At 304, the method 300 receives a connect signal from the port 128. At 306, the method 300 receives a user identification. At 308, the method 300 determines user vehicle preference data based on the user identification. At 310, the method 300 receives at least one vehicle characteristic. At 312, the method 300 selectively adjusts the at least one vehicle characteristic based on the user vehicle preference data. The method 300 ends at 314.

With particular reference to FIG. 4, an exemplary augmented battery equipped vehicle power management method 400 begins at 402. At 404, the method 400 receives a connect signal from the port 128. At 406, the method 400 receives a plurality of internal sensor signals from the internal sensor 120. At 408, the method 400 determines at least one augmented battery characteristic based on the internal sensor signals. At 410, the method 400 executes a power management function based on the at least one augmented battery characteristic. At 412, the method 400 communicates power management function data to a user. At 414, the method 400 receives a disconnect signal from the port 128. At 416, the method 400 generates a power management report. At 418, the method 400 communicates the power management report to the user. The method 400 ends at 420.

With particular reference to FIG. 5, an exemplary augmented battery equipped vehicle user assistances method 500 begins at 502. At 504, the method 500 receives a connect signal from the port 128. At 506, the method 500 receives a plurality of internal sensor signals from the internal sensor 120. At 508, the method 500 receives a plurality of external sensor signals from the external sensors 148. At 510, the method 500 executes a power management function based on the sensor signals. At 512, the method 500 determines a vehicle status. At 514, the method 500 communicates to a user based on the vehicle status. At 516, the method 500 determines whether the user responded to the communication. If false, the method continues at 518. If true, the method 500 continues at 522. At 518, the method 500 generates an assistance alert. At 520, the method 500 communicates the assistance alert to an emergency system. At 522, the method 500 executes a power management function based on the response. At 524, the method 500 communicates power management function data to the user. The method 500 ends at 526.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An augmented battery for providing power to a powered vehicle capable of carrying a human comprising:
a case adapted for removably mounting on the vehicle that encloses:
at least one cell disposed within the case that provides power to the vehicle;
a power port supported by the case that is adapted to electrically couple the at least one cell to the vehicle; and
a processor disposed within the case and having an associated memory that stores program code executable by the processor to selectively communicate through an electronic communication circuit.

2. The augmented battery of claim 1 wherein the processor is programmed to selectively repurpose the augmented battery to perform a selected one of the following functions: supply power to the vehicle, operate as a communication hub, provide emergency help in event of vehicle crash, provide vehicle diagnostic functions, and provide vehicle operating instruction.

3. The augmented battery of claim 2 wherein the processor is programmed to automatically change the selected function upon detecting the battery has been disconnected from the vehicle.

4. The augmented battery of claim 1 wherein the processor is programmed to dynamically supply power to the vehicle based on sensed biological characteristic of an operator of the vehicle.

5. The augmented battery of claim 1 wherein the processor is programmed to mediate check-in and check-out of the vehicle from a vehicle fleet management system.

6. The augmented battery of claim 5 further comprising at least one sensor disposed within the case that is adapted to communicate with the processor and that senses an identity of the vehicle.

7. The augmented battery of claim 6 wherein the processor generates a check-out status signal when the power port is electrically coupled to the vehicle based on the sensed identity of the vehicle and that communicates the check-out status signal to a fleet management system.

8. The augmented battery of claim 7 wherein the processor generates a check-in status signal when the power port is uncoupled from the vehicle.

9. The augmented battery of claim 8 further comprising a global position system (GPS) sensor that is adapted to communicate with the processor and that senses a global position of the vehicle when the power port is uncoupled from the vehicle.

10. The augmented battery of claim 9 wherein the processor communicates the global position and the check-in status signal to the fleet management system.

11. A method for providing power to a powered vehicle capable of carrying a human comprising:
enclosing at least one cell, a power port, and a processor having an associated memory and removably mounting the enclosed at least one cell, the enclosed power port, and the enclosed processor on the vehicle;
storing executable code;
providing power to the vehicle;
electrically coupling the at least one cell to the vehicle; and
selectively communicating through an electronic communication circuit.

12. The method of claim 11 further comprising selectively repurposing the augmented battery to perform a selected one of the following functions: supply power to the vehicle, operate as a communication hub, provide emergency help in event of vehicle crash, provide vehicle diagnostic functions, and provide vehicle operating instruction.

13. The method of claim 12 further comprising automatically changing the selected function upon detecting the battery has been disconnected from the vehicle.

14. The method of claim 11 further comprising dynamically supplying power to the vehicle based on a sensed biological characteristic of an operator of the vehicle.

15. The method of claim 11 further comprising mediating check-in and check-out of the vehicle from a vehicle fleet management system.

16. The method of claim 15 further comprising sensing an identity of the vehicle and communicating with the augmented battery.

17. The method of claim 16 further comprising electrically coupling the augmented battery to the vehicle, generating a check-out status signal based on the sensed identity of the vehicle, and communicating the check-out status signal to the fleet management system.

18. The method of claim 17 further comprising generating a check-in status signal when the augmented battery is uncoupled from the vehicle.

19. The method of claim 18 further comprising sensing a global position of the vehicle when the augmented battery is uncoupled from the vehicle and communicating the global position and the check-in status signal to the fleet management system.

20. An augmented battery for providing power to an electric bicycle comprising:
a case adapted for removably mounting on the electric bicycle that encloses:
a plurality of cells having a combined voltage of between 12 volts and 36 volts disposed within the case that provides power to the electric bicycle;
a power port supported by the case that is adapted to electrically couple the plurality of cells to the electric vehicle; and
a processor disposed within the case and having an associated memory that stores program code executable by the processor to selectively communicate through an electronic circuit and selectively perform at least one electric bicycle management function based on a plurality of received sensor data.
